(19) United States
(12) Patent Application Publication
(10) Pub. No.: US 2013/0086610 A1
(43) Pub. Date: Apr. 4, 2013

(54) Visual Element, Method and System

(71) Applicant: ActiveVideo Networks B.V., Hilversum (NL)

(72) Inventor: Ronald A. Brockmann, Utrecht (NL)

(73) Assignee: ActiveVideo Networks B.V., Hilversum (NL)

(21) Appl. No.: 13/686,548

(22) Filed: Nov. 27, 2012

Related U.S. Application Data
(63) Continuation of application No. PCT/NL2011/050382, filed on May 30, 2011.

(30) Foreign Application Priority Data
May 28, 2010 (NL) 2004780

(51) Int. Cl. G06F 3/0481

(52) U.S. Cl. CPC G06F 3/04812
USPC 725/37; 715/822; 715/760

(57) ABSTRACT

The present invention relates to a method for displaying a user interface comprising a number of elements on which the user can focus his/her attention as desired, comprising steps for: rendering elements which together form the graphic user interface, distinguishing the element of the actual focus of the user, providing a visual effect to be further rendered in respect of the element of the actual focus, and rendering the visual effect in the user interface, whereby the attention of the user is directed relatively easily to the element of the actual focus.

### CROSS-REFERENCE TO RELATED APPLICATIONS

This application is a continuation of International Application PCT/NL2011/050382, filed May 30, 2011, which claims the benefit of Netherlands Application no. 2004780, filed May 28, 2010. The contents of these applications are incorporated by reference in their entirety.

### TECHNICAL FIELD

The present invention relates to a method for displaying a user interface comprising a number of elements on which the user can focus his/her attention as desired.

### BACKGROUND ART

Graphic user interfaces are becoming increasingly richer and more complex. An element used to increasing extent is a multimedia element, user element and animation element. In such a user interface it is increasingly difficult to distinguish a focus element within the overwhelming visual activity of all moving elements.

### SUMMARY OF THE EMBODIMENTS

In order to provide a solution for such a user problem the present invention relates to a method for displaying a user interface comprising a number of elements on which the user can focus his/her attention as desired, comprising steps for: rendering elements which together form the graphic user interface, distinguishing the element of the actual focus of the user, providing a visual effect to be further rendered in respect of the element of the actual focus, and rendering the visual effect in the user interface, whereby the attention of the user is directed relatively easily to the element of the actual focus.

The user is assisted in finding the relevant focus element in the commotion of the user interface by applying such a visual effect.

In a first preferred embodiment the visual effect in respect of the element of the actual focus is an increased luminance and/or an increased light intensity in the immediate surrounding area of the element of the actual focus. It hereby becomes possible to impart an overall, directly recognizable distinctiveness relative to the rest of the elements of the user interface in that the surrounding area is brighter than the area surrounding the other elements.

In a further preferred embodiment the visual effect in respect of the element of the actual focus is an increased luminance and/or an increased light intensity of the element of the actual focus. It hereby becomes possible to impart an overall, directly recognizable distinctiveness relative to the rest of the elements of the user interface in that the element is brighter than the rest of the elements. Alternatively, it is possible to reduce the brightness of the other elements or the rest of the surrounding area. The visual result is similar.

In a further preferred embodiment the visual effect in respect of the element of the actual focus is an imitation of a number of lighting effects of a follow spot, more preferably an illuminated circle as if the element and the immediate surrounding area are being illuminated by means of a follow spot, more preferably also comprising a light beam as if this originated from a follow spot. On the screen it appears as follows. Extending from a determined position at the edge of the screen is a beam of brightness becoming steadily wider which ends at a circular area of a higher luminance than the rest of the graphic user interface. The beam and the circular area provide the effect of a follow spot being filmed from the rear of a hall. Such a visual effect is for instance applied in animation films to imitate a follow spot.

The visual effect is more preferably displaced from an element of the actual focus to a subsequent element of the actual focus on the basis of input by a user. It hereby appears as if the user is operating a follow spot.

In a further preferred embodiment the method is applied as addition to a display algorithm of a selection screen for selecting photos, video fragments or further elements in a distributed video on-demand system, such as comprising central servers for providing image information, such as television signals, graphic user interfaces and web interfaces.

The method is more preferably applied as addition to a display algorithm of a selection screen for selecting photos, video fragments or further elements in a computer device such as a PC, multimedia device, media player, mobile phone.

Alternatively, the method is applied as addition to a display algorithm of a selection screen for selecting photos, video fragments or further elements from a video player, such as a DVD player, hard disk recorder, personal video recorder, digital video recorder.

According to a further preferred embodiment, the method is executed on a central server for the purpose of displaying the graphic user interface on a television, wherein the signals are received via a network, such as the internet, by means of a set top box which is separate or integrated into the television, the control signals are transmitted from a control element such as a remote control of a user to the central server, and wherein the central server converts the control signals to a change in the actual focus. It becomes possible here to apply the advantages of the new user interface according to the present invention in a distributed system, or a local system. The elements on which the user can focus his/her attention are more preferably elements of a web page displayed by means of a web browser. It hereby becomes possible to apply the advantages of easy recognition of the actual element in web pages.

In order to determine the elements to be influenced by the visual effect by means of a script, all elements to be rendered by the web browser, such as HTML elements, are more preferably signaled and all signaled elements are preferably provided here with a shadow effect. A shadow effect is more preferably created by means of an X and Y shift which is predetermined or to be further determined, preferably with attached filters such as a Gaussian blur or a desaturation, for the purpose of causing a shadow effect.

A further preferred embodiment comprises the method steps of sending the graphic interface to a screen such as a television or a computer monitor.

### BRIEF DESCRIPTION OF THE DRAWINGS

The foregoing features of embodiments will be more readily understood by reference to the following detailed description, taken with reference to the accompanying drawings, in which:

FIG. 1 shows a schematic representation of a graphic user interface applying a preferred embodiment according to the present invention.

FIG. 2 shows a flow diagram of a further preferred embodiment.

FIG. 3 shows a block diagram of a further preferred embodiment according to the present invention.

### DETAILED DESCRIPTION OF SPECIFIC EMBODIMENTS

The international patent application having publication number WO 2008/044916, published Apr. 17, 2008 and naming the same inventor, discloses a system for supplying image information to local users by means of a plurality of individual video streams on the basis of for instance a video codec. For this purpose the images are generated on the basis of for instance, a plurality of individual applications which are executed on a central server, on the basis of which individual video streams are generated in the central server. This patent application also comprises a number of optimizations of this general principle. The content of this international patent application is deemed included in this text by way of reference in its entirety, and is reproduced herein as Appendix A, for the purpose of providing a combined disclosure of all individual aspects of this earlier application in combination with individual aspects of this present application text.

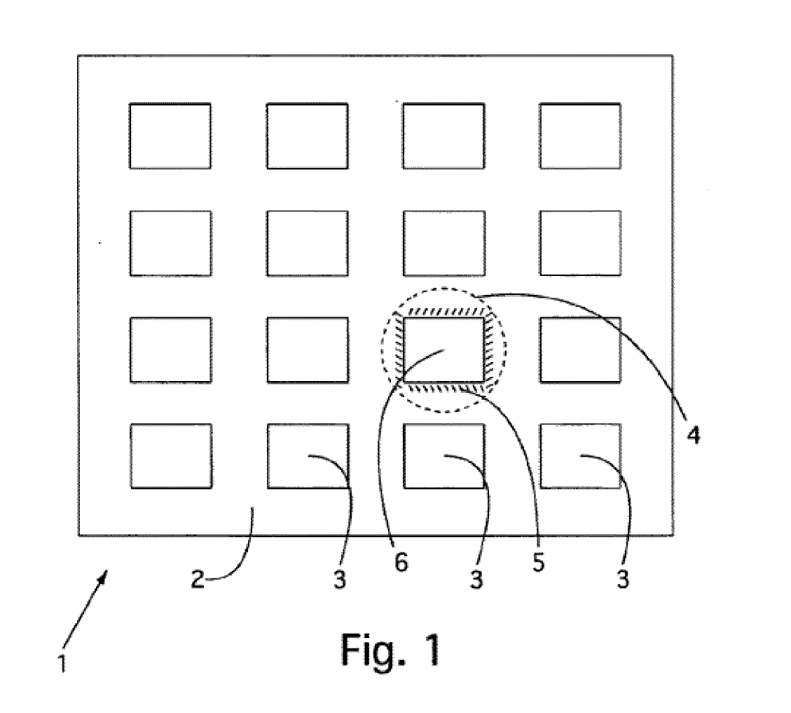

FIG. 1 shows a graphic user interface 1, wherein sixteen small-display video streams 3 are shown on a background 2. The intention of this page of the graphic user interface is that a user selects one of these sixteen video streams 3 to display on the full screen. The display of sixteen video streams 3 involves an enormous graphic load for the user, who appears not very well able to distinguish which has been selected for focus. According to a preferred embodiment, a focused element 6 is therefore surrounded by an illuminated circle 4, whose background has a higher luminance than the surrounding area. The video information of the active element 6 is further displayed more brightly than the video information of the other fifteen elements. A shadow element 5 is further provided, whereby when the shadow element 5 is displayed it appears to the user as if the selected image element 6 is displayed in raised manner relative to the rest of the page.

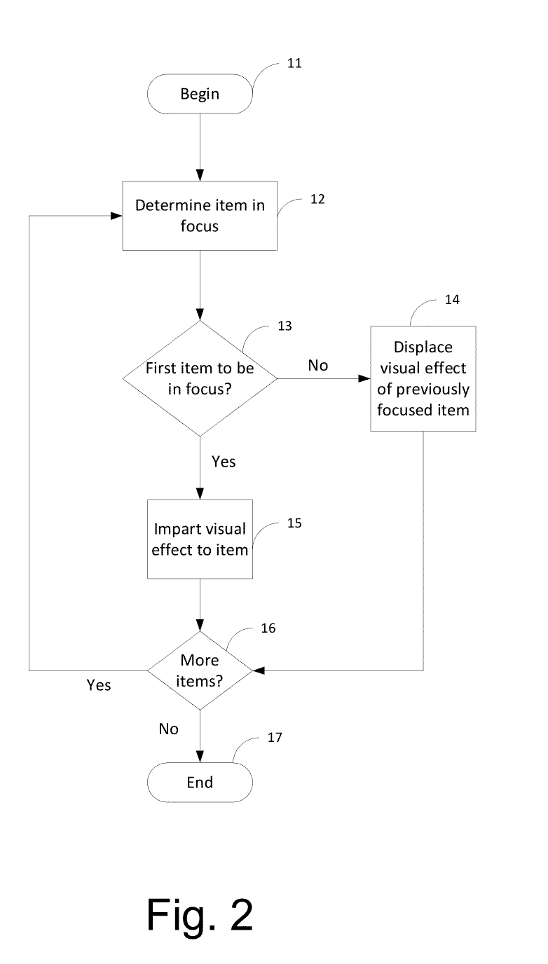

FIG. 2 shows a method for imparting a focus or a visual effect to an element of a graphic user interface. The method begins at step 11. In step 12, it is determined which item on the page obtains the focus on the basis of an action of the user. In step 13, it is determined whether this item is the first item with a focus for a visual effect. If this is not the case, then in step 14 the visual effect of the preceding item is displaced to the item designated by the user. However, if in step 13 it has been determined that there was no preceding item with the visual effect, the method continues in step 15 in which a visual effect is imparted to the item designated by the user. In step 16 it is determined whether another item obtains focus. If so, the method is subsequently returned to step 12. Otherwise, the method ends at step 17.

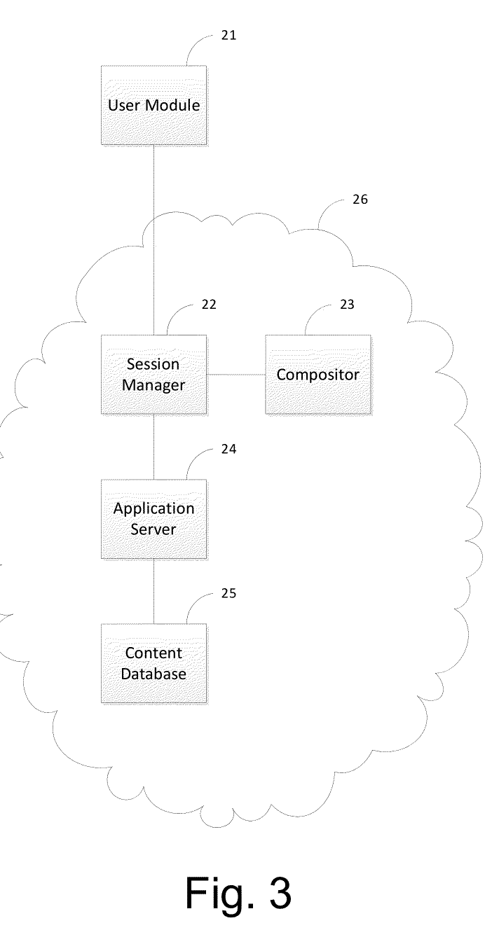

FIG. 3 shows a distributed system for video rendering in line with patent publication WO2008/044916 reproduced in Appendix A, details of which may be found therein. The system comprises a user module 21 that includes a set top box and a TV. Situated in the cloud 26 is a system comprising a session manager 22, a compositor 23, an application server 24 and a database with content information 25.

The information displayed on the television screen is supplied to the user as a data stream from the system in the cloud 26. In accordance with embodiments of the present invention, on the basis of the stated instructions from the user, the stream is modified such that the visual effect is superimposed on the active element 5 of the interface for display on the TV.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

It should be noted that logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. Method for displaying a user interface comprising a number of elements on which the user can focus his/her attention as desired, comprising steps for:
rendering elements which together form the graphic user interface,
distinguishing the element of the actual focus of the user,
providing a visual effect to be further rendered in respect of the element of the actual focus, and
rendering the visual effect in the user interface, whereby the attention of the user is directed relatively easily to the element of the actual focus.

2. Method as claimed in claim 1, wherein the visual effect in respect of the element of the actual focus is an increased luminance and/or an increased light intensity in the immediate surrounding area of the element of the actual focus.

3. Method as claimed in claim 1, wherein the visual effect in respect of the element of the actual focus is an increased luminance and/or an increased light intensity of the element of the actual focus.

4. Method as claimed in claim 1, wherein the visual effect in respect of the element of the actual focus is an imitation of one or more lighting effects of a follow spot, more preferably an illuminated circle as if the element and the immediate surrounding area are being illuminated by means of a follow spot, more preferably also comprising a light beam as if this originated from a follow spot.

5. Method as claimed in claim 1, wherein the visual effect is displaced from an element of the actual focus to a subsequent element of the actual focus on the basis of input by a user.

6. Method as claimed in claim 1, which is applied as addition to a display algorithm of a selection screen for selecting photos, video fragments or further elements in a distributed video on demand system, such as comprising central servers for providing image information, such as television signals, graphic user interfaces and web interfaces.

7. Method as claimed in claim 1, which is applied as addition to a display algorithm of a selection screen for selecting photos, video fragments or further elements in a computer device such as a PC, multimedia device, media player, mobile phone.

8. Method as claimed in claim 1, which is applied as addition to a display algorithm of a selection screen for selecting photos, video fragments or further elements from a video player, such as a DVD player, hard disk recorder, personal video recorder, digital video recorder.

9. Method as claimed in claim 1, wherein the method is executed on a central server for the purpose of displaying the graphic user interface on a television, wherein the signals are received via a network, such as the Internet, by means of a set top box which is separate or integrated into the television, the control signals are transmitted from a control element such as a remote-control of a user to the central server, and wherein the central server converts the control signals to a change in the actual focus.

10. Method as claimed in claim 1, wherein the elements on which the user can focus his/her attention are elements of a web page displayed by means of a web browser.

11. Method as claimed in claim 10, wherein in order to determine the elements to be influenced by the visual effect by means of a script, all elements to be rendered by the web browser, such as HTML elements, are signaled and all signaled elements are preferably provided here with a shadow effect.

12. Method as claimed in claim 11, wherein a shadow effect is created by means of an X and Y shift which is predetermined or to be further determined, preferably with attached filters such as a Gaussian blur or a desaturation, for the purpose of causing a shadow effect.

13. Method as claimed in claim 1, comprising sending the graphic interface to a screen such as a television or a computer monitor.
